(19) United States
(12) Patent Application Publication
(10) Pub. No.: US 2005/0251283 A1
(43) Pub. Date: Nov. 10, 2005

(54) Computer programed method of forming and fabricating parts into an assembly

(76) Inventors: Gerald L. Shovan, Chesterfield Township, MI (US); Steven Lee Kostos, Riley, MI (US)

Correspondence Address: HOWARD & HOWARD ATTORNEYS, P.C., THE PINEHURST OFFICE CENTER, SUITE #101, 39400 WOODWARD AVENUE, BLOOMFIELD HILLS, MI, 48304-5151, US

(21) Appl. No.: 11/115,955

(22) Filed: Apr. 27, 2005

Related U.S. Application Data
(60) Provisional application No. 60/566,038, filed on Apr. 28, 2004.

(51) Int. Cl. G06F 19/00

(52) U.S. Cl. 700/145; 29/592

(57) ABSTRACT

A method of fabricating an assembly of at least two parts (20, 22, 24, 26, 28) of metal plates butted together at a welded interface area (30) by using a stored CAD program of the three dimensional coordinates of a first part (20, 22, 24, 26, 32) and a second part (32) including the coordinates of an interface area (30) or outline of the first part (20, 22, 24, 26, 32) onto to the second part (32). The parts (20, 22, 24, 26, 28) are cut from stock about the desired peripheries by a cutting tool (34) guided by a sub-file in the computer program and, while the part (20, 22, 24, 26, 32) remains in the cutting machine (36), the program guides the cutting tool (34) to cut out a recessed area (30) in the second part (32) for receiving the first part (20, 22, 24, 26, 32) into the recessed area (30) of the second part (32). The first part (20, 22, 24, 26, 32) is welded to the second part (32) about the recessed area (30) to create a permanent interface area (30).

### CROSS REFERENCE TO RELATED APPLICATION

This application claims the benefit of provisional application Ser. No. 60/566,038 filed Apr. 28, 2004.

### BACKGROUND OF THE INVENTION

1. Field of the Invention

The subject invention relates to a method of fabricating an assembly of a plurality of parts of metal plates butted together at a welded interface area.

2. Description of the Prior Art

In order to fabricate such parts it has been customary to prepare a detailed drawing of each part with a relatively complete array of interrelated dimensions on the drawing. For example, such dimensions would include lengths and widths with dimensions relative thereto for other shapes in each part plus angles, diameters and axes.

In addition, a fabricator must refer to the drawings to position the parts relative to one another for securing or welding the parts together. This is being done by measuring and manually scribing the parts at the intended interface of the parts.

Accordingly, the present practice is labor intensive and subject to human error.

The prior art have utilized computer controls for etching reference marks and data on the base plate of a gage for positioning and assembling the parts of the gage, as illustrated in U.S. Pat. No. 5,412,877 to McKendrick. However, such indicia are used for assembly and re-assembly of the gage parts and are not part of a fabrication process to permanently assemble and bond parts together at precise overlapping areas.

### SUMMARY OF THE INVENTION AND ADVANTAGES

The invention provides a method of fabricating an assembly of at least two metal parts butted together at an interface area by developing a set of three dimensional coordinates corresponding to an assembly of a first part to a second part, developing a programmed set of instructions using the three dimensional coordinates to form the first and second parts using a computer controlled machine that also marks the second part in the area of the projected interface area with the first part. The very precise marking of the interface by the computer program facilitates positioning the first part against the marked area of the second part for adjoining the first part to the second part at the marked area.

The fabrication of an assembly from parts made in accordance with the subject invention eliminates the need to produce drawings with all of the detail in terms of dimensions that have been previously referred to in the fabrication process. The number of dimensions required on a drawing can be reduced by as much as seventy to ninety percent over past practices. Likewise, the checking can be reduced by the same percentages. The use of a computer program relying on three dimensional coordinates, reduces the opportunity for human error as well as much of the manual activity in mating parts during the assembly process. The subject invention substantially reduces detail and the requirement for checking. The CAD data is used electronically to create an electronic sub-file of three dimensional coordinates thereby reduces the opening for errors.

By cutting or other wise marking the outline of the first part onto the second part while in the cutting machine, the area can be marked in the same machining step for cutting the periphery of the part, i.e., no additional machining steps are required for the area of the mounting interface.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a perspective view of an assembly fabricated in accordance with the subject invention;

Figure is an exploded perspective view of the assembly of FIG. 1;

FIG. 3 is a perspective view of a cutting machine and computer for cutting the parts of an assembly fabricated in accordance with the subject invention;

FIG. 4 is a view of a drawing showing the dimensions required without using the subject invention; and

FIG. 5 is a view of the same part shown in FIG. 4 but showing the minimal dimensions required when using the subject invention.

### DETAILED DESCRIPTION OF THE INVENTION

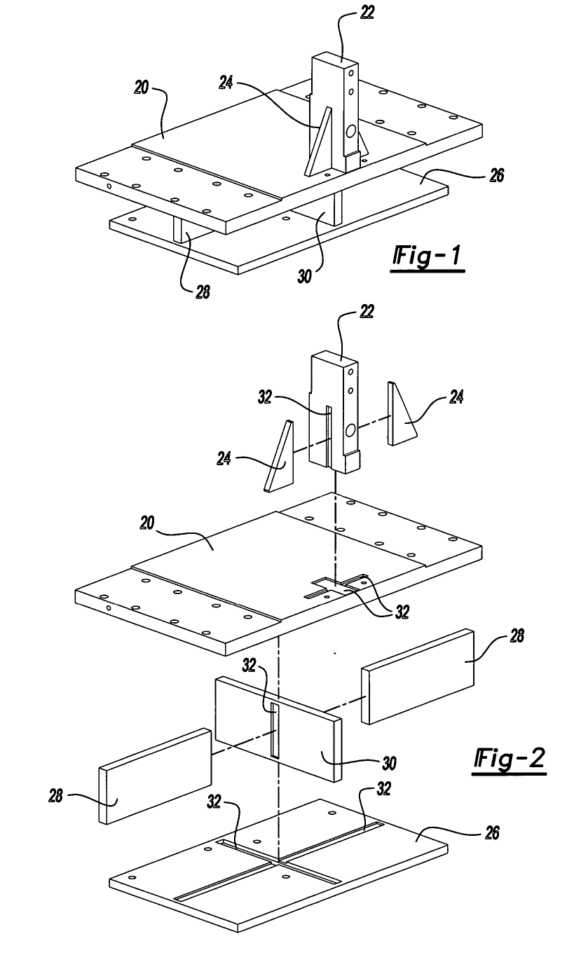

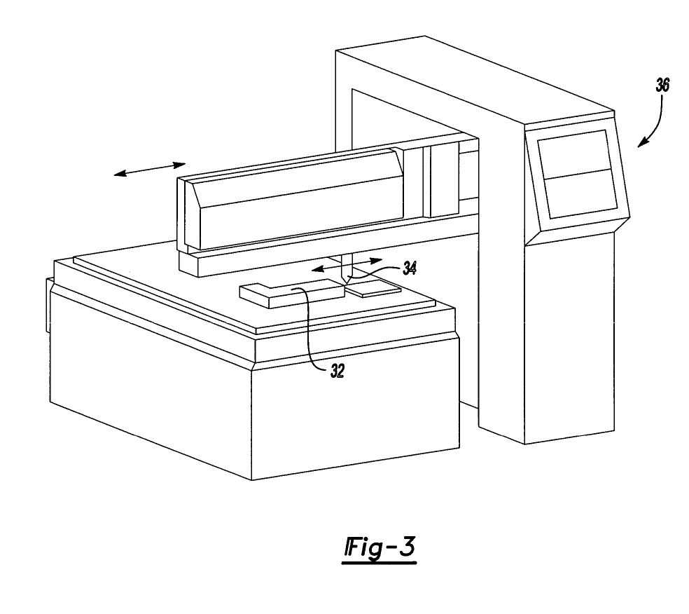

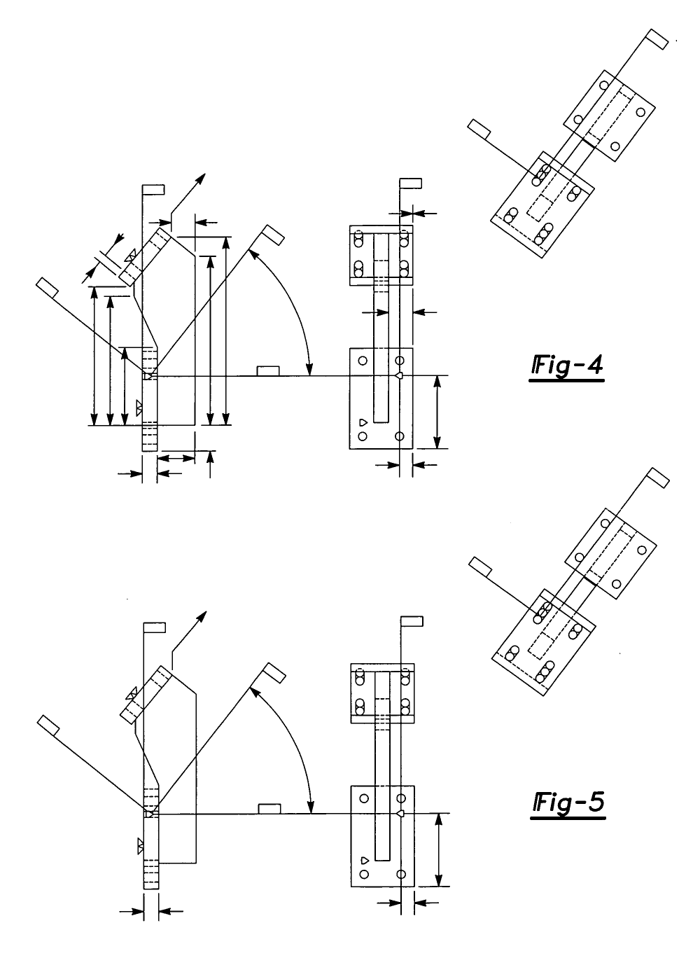

The subject invention provides a method of fabricating an assembly comprising at least two parts 20, 22, 24, 26, 28 defined by metal plates butted together at a welded interface area 30. An assembly illustrating the invention is shown in FIGS. 1 and 2 and includes a plurality of parts 20, 22, 24, 26, 28. The parts 20, 22, 24, 26, 28 are made of metal and include a platform part 20 with a post part 22 extending upwardly from the top surface of the platform part 20 and triangular reinforcement parts 24 or plates extending between opposite sides of the post part 22 and the top surface of the platform part 20. A base part 26 is held below and in spaced and parallel relationship to the platform part 20 by a pair of first parts 28 extending lengthwise of the base part 26 and a second part 32 extending crosswise of the base part 26 with the first parts 28 abutting the sides of the second part 32. All of the parts 20, 22, 24, 26, 28 are formed from sheets or plates of metal by cutting the periphery of the respective parts 20, 22, 24, 26, 28 into or from larger sheets or plates of stock metal. Except for the triangular reinforcement parts 24, all of the remaining parts 20, 22, 24, 26, 28 have a rectangular periphery defined by four edges and opposing faces or sides extending between the edges. As will become more clear hereinafter, most of the parts 20, 22, 24, 26, 28 include a scored area 30 indicating an interface area 30 with the first part 20, 22, 24, 26, 32 and a weld fusing the first part 20, 22, 24, 26, 32 to the second part 32 at the interface area 30. As illustrated, the scored area 30 is defined as a recessed area 30 that receives a portion of the periphery of one of the other parts 20, 22, 24, 26, 28 with the parts 20, 22, 24, 26, 28 welded together about the recessed area 30. In other words, the scored area 30 reflects a projection of portion of the periphery of a first part 20, 22, 24, 26, 32 on a second part 32 and a weld between the parts 20, 22, 24, 26, 28 covers the scored area 30.

The method of fabricating the assembly including at least two parts 20, 22, 24, 26, 28 of metal plates butted together at a welded interface area 30 comprises the steps of storing in a CAD program the three dimensional coordinates of an assembly of a first part 20, 22, 24, 26, 32 and a second part 32 including the coordinates of the interface area 30 of the first part 20, 22, 24, 26, 32 welded to the second part 32. The method includes creating a sub-file in the computer program containing the coordinates of the periphery of each of the parts 20, 22, 24, 26, 28 and the coordinates of the interface area 30 on the second part 32 to which the first part 20, 22, 24, 26, 32 is to be welded. A cutting tool 34 is guided or controlled by a computer in response to the sub-file thereby cutting the first part 20, 22, 24, 26, 32 about its periphery from a plate of metal stock. Similarly, the computer program guides the cutting tool 34 in response to the sub-file thereby cutting the second part 32 about its periphery from a plate of metal stock, the same plate or a different plate of stock.

In addition, the cutting tool 34 is guided by the computer in response to the sub-file to cut out a recessed area 30 in the second part 32 in the area 30 of the projected interface area 30 with the first part 20, 22, 24, 26, 32 it is significant for the purpose of efficiency that the second part 32 have the recess cut therein while in the cutting machine 36. In other words, stock material is placed in a cutting machine 36 supporting the cutting tool 34 for cutting the second part 32 from the stock material and to also cut out the recessed area 30 while the second part 32 remains in the cutting machine 36, i.e., without re-fixturing the second part 32 in the cutting machine 36.

During the fabrication, a portion of the periphery of the first part 20, 22, 24, 26, 32 is inserted into the recessed area 30 of the second part 32 and the first part 20, 22, 24, 26, 32 is welded to the second part 32 about the recessed area 30 to create a permanent interface area 30. The cutting may be accomplished by a water jet or a laser, or any equivalent cutting device. It is important that the second part 32 be marked with an indicia that outlines the area 30 which abuts the first part 20, 22, 24, 26, 32 so that an assembler can see precisely where to place the parts 20, 22, 24, 26, 28 relative to one another for welding the parts 20, 22, 24, 26, 28 together, i.e., creating a homogeneous fusion or integral bond between the parts 20, 22, 24, 26, 28.

Accordingly, the method of fabricating an assembly of at least two metal parts 20, 22, 24, 26, 28 butted together at an interface area 30 comprises the steps of developing a set of three dimensional coordinates corresponding to an assembly of a first part 20, 22, 24, 26, 32 to a second part 32, i.e., storing in a CAD program the three dimensional coordinates of an assembly of a first part 20, 22, 24, 26, 32 and a second part 32 including the coordinates of an interface area 30 of the first part 20, 22, 24, 26, 32 outlined onto the second part 32. In a more specific sense, a sub-file in the computer program is created to contain the coordinates of the periphery of each of the parts 20, 22, 24, 26, 28 and the coordinates of the outline or area 30 of the interface area 30 on the second part 32 to which the first part 20, 22, 24, 26, 32 is to be engaged and bonded, i.e., the outline of the first part 20, 22, 24, 26, 32 on the second part 32. Also included is the developing of a programmed set of instructions using the three dimensional coordinates to form the first part 20, 22, 24, 26, 32 from metal using a computer controlled machine 36 operated by the programmed set of instructions, as well as forming the second part 32 from metal using the computer controlled machine 36 operated by the programmed set of instructions. The method is distinguished by marking the metal of the second part 32 in the area 30 of the projected interface area 30 with the first part 20, 22, 24, 26, 32 using the computer controlled machine 36 operated by the programmed set of instructions, before positioning the first part 20, 22, 24, 26, 32 against the marked area 30 of the second part 32, so that the first part 20, 22, 24, 26, 32 may be welded to the second part 32 at the marked area 30 between the first part 20, 22, 24, 26, 32 and the second part 32. It is be understood that the scored area 30 may take any form so long as the projected area 30 where the first part 20, 22, 24, 26, 32 engages the second part 32 is visible so that the first part 20, 22, 24, 26, 32 may be very accurately placed in position for permanently bonding the first part 20, 22, 24, 26, 32 to the second part 32 at the engagement of the first part 20, 22, 24, 26, 32 against the scored area 30 of the second part 32 to create the permanent interface area 30.

Obviously, many modifications and variations of the present invention are possible in light of the above teachings. The invention may be practiced otherwise than as specifically described within the scope of the appended claims.

1. A method of fabricating an assembly of at least two parts (20, 22, 24, 26, 28) of metal plates butted together at a welded interface area (30) comprising the steps of;
storing in a CAD program the three dimensional coordinates of an assembly of a first part (20, 22, 24, 26, 32) and a second part (32) including the coordinates of an interface area (30) of the first part (20, 22, 24, 26, 32) welded to the second part (32),
creating a sub-file containing the coordinates of the periphery of each of the parts (20, 22, 24, 26, 28) and the coordinates of the area (30) of the interface area (30) on the second part (32) to which the first part (20, 22, 24, 26, 32) is to be welded,
guiding a cutting tool (34) with a computer in response to the sub-file and cutting the first part (20, 22, 24, 26, 32) about its periphery from a plate of metal stock,
guiding the cutting tool (34) with the computer in response to the sub-file and cutting the second part (32) about its periphery from a plate of metal stock,
guiding the cutting tool (34) with the computer in response to the sub-file and cutting out a recessed area (30) in the second part (32) in the area (30) of the projected interface area (30) with the first part (20, 22, 24, 26, 32) in response to the sub-file,
inserting a portion of the periphery of the first part (20, 22, 24, 26, 32) into the recessed area (30) of the second part (32), and
welding the first part (20, 22, 24, 26, 32) to the second part (32) about the recessed area (30) to create the permanent interface area (30).

2. A method as set forth in claim 1 wherein said cutting and said scoring are further defined as cutting and scoring with a water jet.

3. A method as set forth in claim 1 including placing stock material in a cutting machine (36) supporting the cutting tool (34) and cutting said second part (32) and cutting out the recessed area (30) while the second part (32) remains in the cutting machine (36).

4. A method of fabricating an assembly of at least two metal parts (20, 22, 24, 26, 28) butted together at an interface area (30) comprising the steps of;
developing a set of three dimensional coordinates corresponding to an assembly of a first part (20, 22, 24, 26, 32) to a second part (32),
developing a programmed set of instructions using the three dimensional coordinates,
forming the first part (20, 22, 24, 26, 32) from metal using a computer controlled machine (36) operated by the programmed set of instructions,
forming the second part (32) from metal using the computer controlled machine (36) operated by the programmed set of instructions,
marking the metal of the second part (32) in the area (30) of the projected interface area (30) with the first part (20, 22, 24, 26, 32) using the computer controlled machine (36) operated by the programmed set of instructions,
positioning the first part (20, 22, 24, 26, 32) against the marked area (30) of the second part (32), and
welding the first part (20, 22, 24, 26, 32) to the second part (32) at the marked area (30) between the first part (20, 22, 24, 26, 32) and the second part (32).

5. A method of fabricating an assembly of at least two parts (20, 22, 24, 26, 28) butted together at an interface area (30) comprising the steps of;
storing in a CAD program the three dimensional coordinates of an assembly of a first part (20, 22, 24, 26, 32) and a second part (32) including the coordinates of an interface area (30) of the first part (20, 22, 24, 26, 32) bonded to the second part (32),
creating a sub-file containing the coordinates of the periphery of each of the parts (20, 22, 24, 26, 28) and the coordinates of the area (30) of the interface area (30) on the second part (32) to which the first part (20, 22, 24, 26, 32) is to be bonded,
cutting the first part (20, 22, 24, 26, 32) about its periphery with a cutting machine (36) controlled by the sub-file,
cutting the second part (32) about its periphery with a cutting machine (36) controlled by the sub-file,
scoring the second part (32) in the area (30) of the interface area (30) between the parts (20, 22, 24, 26, 28) with a cutting machine (36) controlled by the sub-file,
engaging the first part (20, 22, 24, 26, 32) against the scored area (30) of the second part (32), and
permanently bonding the first part (20, 22, 24, 26, 32) to the second part (32) at the engagement of the first part (20, 22, 24, 26, 32) against the scored area (30) of the second part (32) to create the permanent interface area (30).

6. An assembly of at least two parts (20, 22, 24, 26, 28) comprising;
a first part (20, 22, 24, 26, 32) made of metal and having a periphery,
a second part (32) made of metal and having a periphery, and
characterized by a machine (36) scored area (30) indicating an interface area (30) with the first part (20, 22, 24, 26, 32) and a weld fusing said first part (20, 22, 24, 26, 32) to said second part (32) at said interface area (30).

7. An assembly as set forth in claim 6 wherein said scored area (30) reflects a projection of said first part (20, 22, 24, 26, 32) on said second part (32) and said weld covers said scored area (30).

8. An assembly as set forth in claim 6 wherein said scored area (30) comprises a recessed area (30) in said second part (32) for receiving said first part (20, 22, 24, 26, 32) and said weld extends about said recessed area (30).
